(19) United States
(12) Patent Application Publication
(10) Pub. No.: US 2026/0328182 A1
(43) Pub. Date: Oct. 22, 2026

(54) DOUBLE-HELIX VERTICAL AXIS WIND TURBINE

(71) Applicant: Rensselaer Polytechnic Institute, Troy, NY (US)

(72) Inventor: Jeffrey L. Osborne, Danbury, CT (US)

(73) Assignee: Rensselaer Polytechnic Institute, Troy, NY (US)

(21) Appl. No.: 19/116,667

(22) PCT Filed: Oct. 5, 2023
(86) PCT No.: PCT/US2023/034507

§ 371 Date: Mar. 28, 2025

Related U.S. Application Data
(60) Provisional application No. 63/413,361, filed on Oct. 5, 2022.
(60) Provisional application No. 63/542,554, filed on Oct. 5, 2023.

(51) Int. Cl. F03D 3/00; F03D 3/04; H02K 7/116; H02K 7/18

(52) U.S. Cl. CPC F03D 3/005; F03D 3/0472; H02K 7/116; H02K 7/183; F05B 2220/706

(57) ABSTRACT

A wind turbine includes a frame that has a top portion and a bottom portion defining a longitudinal axis of the wind turbine. A cylindrical core is substantially centrally located in the frame along the longitudinal axis and is configured to rotate about the longitudinal axis. A pair of airfoils is connected to the cylindrical core and is configured to collect incident wind to rotate the cylindrical core. The airfoils are diametrically opposed to each other and wrap around the cylindrical core along the longitudinal axis in a double-helical shape thereby forming a wind collection side on a first longitudinal side and a wind drag side on a second longitudinal side. A wind deflector is connected to the frame and is configured to divert wind incident on the wind drag side to the wind collection side for collection by the pair of airfoils.

### CROSS REFERENCE TO RELATED APPLICATIONS

This application claims the priority benefit of U.S. Provisional Patent Application No. 63/413,361, filed Oct. 5, 2022, and U.S. Provisional Patent Application No. 63/542,554, filed Oct. 5, 2023, the contents of which are incorporated by reference as if disclosed herein in their entireties.

### FIELD

The present technology relates generally to devices for extracting energy from a flowing medium, and more particularly, to vertical axis wind turbine devices.

### BACKGROUND

The growing concern for the health and sustainability of our planet over the past half-century has inspired a generation of engineers and scientists with the next great challenge in our modern world: a net-zero sustainable energy infrastructure. Although great progress has been made with regards to integrating renewable energy, the current technology is still incapable of powering our modern societies as a standalone energy source. Almost all countries, despite renewable innovations, are still massively dependent on fossil fuels for energy.

Wind flowing through urban environments forms a phenomenon called the “street canyon effect.” The street canyon effect describes the accelerated wind gusts that occur in dense, urban environments and results from the wind flow being constrained and redirected by the densely packed buildings and skyscrapers of a city layout. These faster wind speeds offer an opportunity to generate significant wind power. However, traditional wind turbines are unable to efficiently generate wind power from street canyon effect winds. Traditional wind turbines are generally too large to be installed in urban environments and/or cannot capture enough wind to justify their installation.

What is needed, therefore, are improved wind turbines and systems that address at least the problems described above.

### SUMMARY

According to an embodiment of the present technology, a wind turbine is provided. The wind turbine includes a frame that has a top portion and a bottom portion defining a longitudinal axis of the wind turbine. A cylindrical core is substantially centrally located in the frame along the longitudinal axis and is configured to rotate about the longitudinal axis. At least one pair of airfoils is connected to the cylindrical core and is configured to collect incident wind to rotate the cylindrical core. The airfoils of the at least one pair of airfoils are diametrically opposed to each other and wrap around the cylindrical core along the longitudinal axis in a double-helical shape thereby forming a wind collection side on a first longitudinal side of the wind turbine and a wind drag side on a second longitudinal side of the wind turbine. A wind deflector is connected to the frame and is configured to divert wind incident on the wind drag side to the wind collection side for collection by the at least one pair of airfoils.

In some embodiments, the cylindrical core includes a dowel that passes therethrough along the longitudinal axis. The dowel has a first axial end connected to the top portion of the frame via a ball bearing and a second axial end connected to a gearbox adjacent the bottom portion of the frame such that the cylindrical core is configured to rotate within the frame.

In some embodiments, the gearbox includes a generator connected to the second axial end of the dowel such that rotation of the cylindrical core drives the generator to produce electrical power.

In some embodiments, the top portion of the frame and the bottom portion of the frame each have an annular shape. The wind deflector has a first axial end that is slidably connected to a circumferential edge of the top portion and a second axial end that is slidably connected to a circumferential edge of the bottom portion such that the wind deflector is slidable along a circumference the frame.

In some embodiments, the frame includes a plurality of supports connecting the top portion and the bottom portion. A cylindrical cage is connected to at least one of the plurality of supports and at least partially encloses the cylindrical core.

In some embodiments, the frame is configured to be mounted to a vertical structure via at least one of the plurality of supports.

In some embodiments, the wind deflector includes a rod aligned with the longitudinal axis and a panel connected to the rod. The rod has a first axial end that is slidably positioned in a first perimeter track of the top portion of the frame and a second axial end that is slidably positioned in a second perimeter track of the bottom portion of the frame such that the wind deflector is slidable along a perimeter of the frame. The panel protrudes outward from the frame and is configured to collect wind incident on the wind drag side of the wind turbine and divert to the collected wind to the wind collection side of the wind turbine.

In some embodiments, a wind vane is mounted atop the frame and is configured to rotate and align with a direction of incident wind. The wind vane has an arm connected to the rod of the wind deflector that is configured to slide the wind deflector along the perimeter of the frame as the wind vane rotates.

In some embodiments, the panel protrudes outward from the frame at an angle in the range of about 30-degrees to about 60-degrees from a direction of the incident wind. In some embodiments, the panel protrudes outward from the frame at an angle in the range of about 40-degrees to about 50-degrees from a direction of the incident wind. In some embodiments, the panel protrudes outward from the frame at an angle of about 40-degrees from a direction of the incident wind.

In some embodiments, the wind deflector has a substantially rectangular shape. In some embodiments, the wind deflector has a substantially concave shape toward the wind collection side of the wind turbine. In some embodiments, the wind deflector has a proximal portion that is curved toward the wind collection side of the wind turbine, and a distal portion that is substantially linear.

According to another embodiment of the present technology, a system for producing electrical power from wind flowing in a direction is provided. The system includes at least one wind turbine, at least one generator, and at least one wind deflector. Each of the at least one wind turbine includes a cylindrical core that has a first axial end and a second axial end defining a longitudinal axis of the wind turbine, and at least one pair of airfoils connected to the cylindrical core and configured to collect incident wind to rotate the cylindrical core about the longitudinal axis. The airfoils of the at least one pair of airfoils are diametrically opposed to each other and wrap around the cylindrical core along the longitudinal axis in a double-helical shape thereby forming a wind collection side on a first longitudinal side of the wind turbine and a wind drag side on a second longitudinal side of the wind turbine. Each of the at least one generators is connected to a respective one of the at least one wind turbines. The generator is connected to the second axial end of the cylindrical core such that rotation of the cylindrical core drives the generator to produce electrical power. Each of the at least one wind deflector is connected to a respective one of the at least one wind turbines. The wind deflector is configured to divert wind incident on the wind drag side to the wind collection side for collection by the at least one pair of airfoils.

In some embodiments, a frame supports the cylindrical core. The frame includes a top portion connected to the first axial end of the cylindrical core via a ball bearing, and a bottom portion connected to the cylindrical core adjacent to the generator such that the cylindrical core is configured to rotate within the frame.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a perspective view showing the wind flow streamlines over a face of a building.

FIG. 2 is a perspective view of a wind turbine according to some embodiments of the present technology.

FIG. 3 is a perspective view of a rotor used in the wind turbine of FIG. 2 according to some embodiments of the present technology.

FIG. 4A is a top plan view of the wind turbine of FIG. 2.

FIG. 4B is a detail view of Detail A of FIG. 4A.

FIG. 5 is a top perspective view of a wind turbine according to some embodiments of the present technology.

FIG. 6 is a partial side elevational view of the wind turbine of FIG. 5.

FIG. 7A is a perspective view of a wind turbine according to some embodiments of the present technology.

FIG. 7B is a detail view of Detail B of FIG. 7A.

FIG. 8 is a top plan view of a wind turbine according to some embodiments of the present technology mounted to a face of a building.

### DETAILED DESCRIPTION

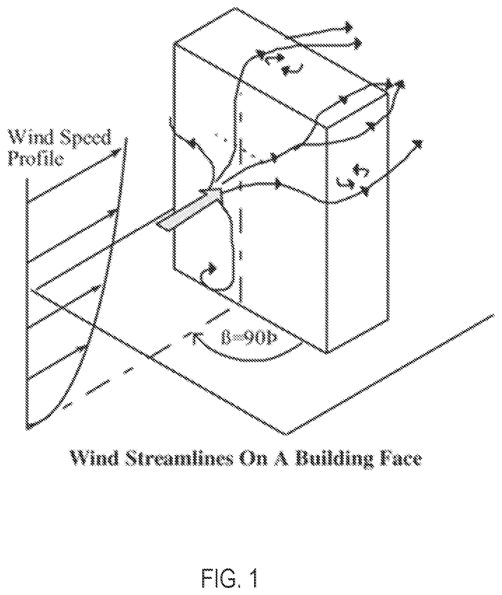

FIG. 1 shows how an incident wind stream is distributed when blown onto the center of a building face. As shown, the wind wraps around the face toward the open channels, except for a downwash portion that is restricted by the ground. For urban street configurations with long channels of buildings, this redirected flow will increase the volume of wind passing through the street channel locations. Per Bernoulli's Principle, this increase in volume results in an increase in the wind speed through the channel.

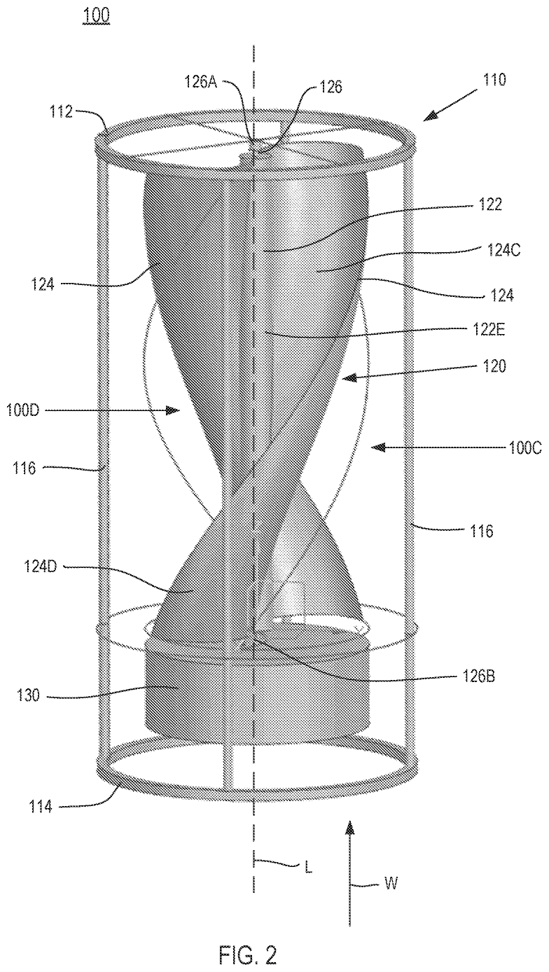

As shown in FIG. 2, a wind turbine is generally designated by the numeral 100. The wind turbine 100 includes a frame 110 that has a top portion 112 and a bottom portion 114 that define a longitudinal axis L of the wind turbine 100. In some embodiments, the top portion 112 and the bottom portion are each annular in shape such that the frame 110 has a substantially cylindrical shape. However, the present technology is not limited thereto and contemplates embodiments where the frame 110 has a different shape, such as a triangular shape, a rectangular shape, a pentagonal shape, a hexagonal shape, etc. A plurality of supports 116 connect the top portion 112 and the bottom portion 114. In some embodiments, the supports 116 are substantially equally spaced along a circumference of the frame 110. In some embodiments, the frame 110 includes four equally spaced supports 116 forming four quadrants. However, the present technology is not limited thereto and contemplated embodiments where the frame 110 has any number of supports 116 in any arrangement, equally spaced or not equally spaced.

The wind turbine 100 includes a rotor 120 that is substantially centrally located in the frame 110 along the longitudinal axis L. The rotor 120 includes a cylindrical core 122 that is configured to rotate about the longitudinal axis L. At least one pair of airfoils 124 are connected to the cylindrical core 122. The airfoils 124 are configured to collect wind incident on the wind turbine 100 to rotate the cylindrical core 122. Each airfoil 124 of the at least one pair of airfoils 124 are diametrically opposed to each other on an exterior circumferential surface 122E of the cylindrical core 122. Each airfoil 124 of the at least one pair of airfoils 124 wrap around the cylindrical core 122 along the longitudinal axis L such that the pair of airfoils 124 forms a double-helix shape. Although the drawing figures show the rotor 120 having one pair of airfoils 124, the present technology is not limited thereto and contemplates embodiments where the rotor 120 has any number of pairs of airfoils 124, such as two pairs, three pairs, four pairs, etc.

In some embodiments, each airfoil 124 is curved from a proximal end 124A that is connected to the cylindrical core 122 to a distal end 124B. In some embodiments, each airfoil 124 is curved to form a wind collection face 124C that is substantially concave shaped, and an opposing wind drag face 124D that is substantially convex shaped. The wind collection face 124C is configured to collect wind incident on the wind turbine 100 to rotate the cylindrical core 122, while the wind drag face 124D is configured to divert incident wind. However, some incident wind is collected by the wind drag face 124D such that the wind drag face 124D of one airfoil 124 resists the rotation by the wind collection face 124C of the opposing airfoil 124, thereby reducing the rotation speed of the rotor 120. Thus, for any direction of incident wind W on the wind turbine 100, the at least one pair of airfoils 124 forms a wind collection side 100C on one side of the longitudinal axis L and a wind drag side 100D on an opposing side of the longitudinal axis L. Notably, the positions of the wind collection side 100C and the wind drag side 100D change depending on the direction of incident wind W.

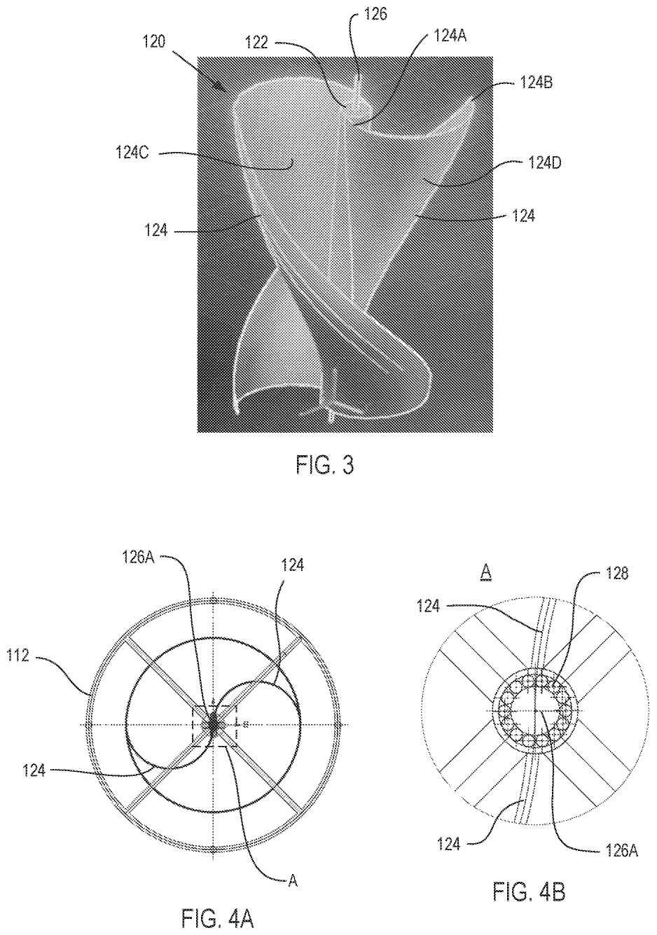

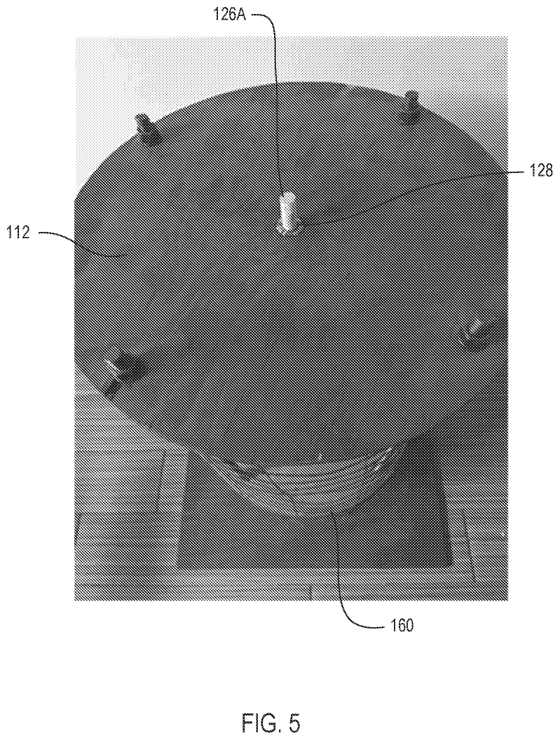

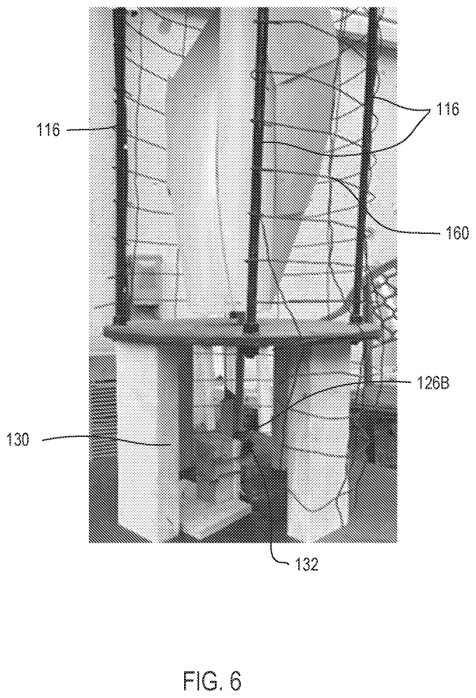

In some embodiments, the rotor 120 includes a dowel 126 that passes through the cylindrical core 122 along the longitudinal axis L, as shown in FIG. 3. The dowel 126 has a first axial end 126A that connects to the top portion 112 of the frame 110, and a second axial end 126B that connects to a gearbox 130 located adjacent to the bottom portion 114 of the frame 110, as shown in FIG. 2. In some embodiments, the first axial end 126A connects to the top portion 112 via a ball bearing 128 such that the dowel 126 is configured to rotate freely (e.g., with minimal friction) within the frame 110 as the cylindrical core 122 rotates, as shown in FIGS. 4A-5. In some embodiments, the second axial end 126B is connected to a generator 132, as shown in FIG. 6, within the gearbox 130 such that rotation of the cylindrical core 122 drives the generator 132 to produce electrical power. In some embodiments, at least one wind turbine 100, and in some embodiments a plurality of wind turbines 100, forms a system that is mounted to a structure 170 (e.g., a building) and is in electrical communication with the structure to produce electrical power from wind incident on the wind turbines 100 and provide the electrical power to the structure.

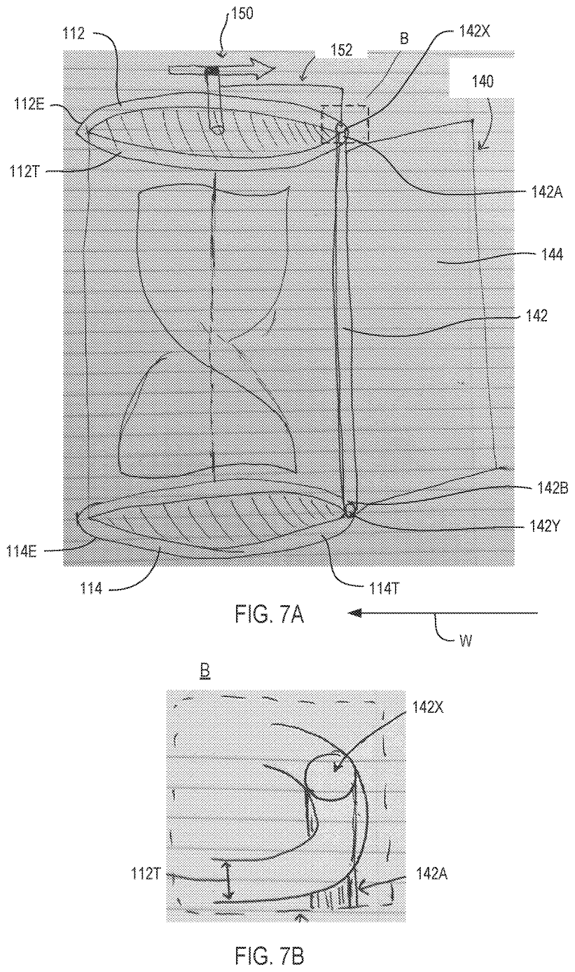

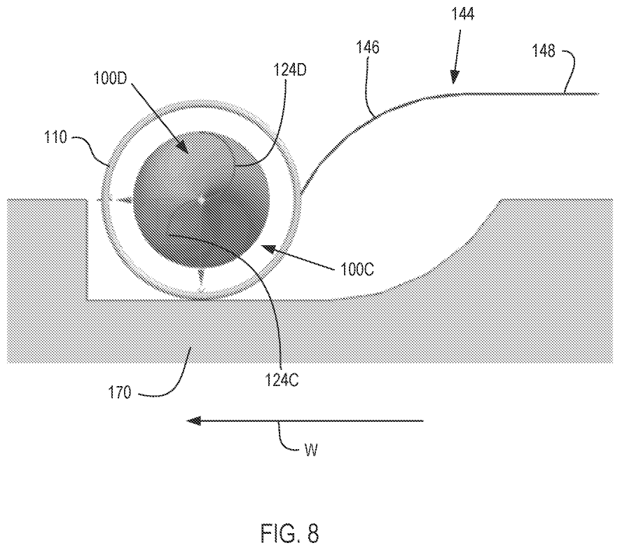

As shown in FIGS. 7A-8, the wind turbine 100 includes a wind deflector 140 that is connected to the frame 110 and is configured to divert wind incident on the wind drag side 100D of the wind turbine 100 to the wind collection side 100C of the wind turbine 100 for collection by the airfoils 124. In some embodiments, the wind deflector 140 has a rod 142 and a panel 144 that is connected to and protrudes outward from the rod 142. The rod 142 has a first axial end 142A that connects to the top portion 112 of the frame 110, and a second axial end 142B that connects to the bottom portion 114 of the frame 110. The wind deflector 140 is positioned such that the panel 144 protrudes from the frame 110 and blocks the wind drag side 100D of the wind turbine 100. Thus, wind that would be incident on the wind drag side 100D of the wind turbine 100 is instead diverted by the panel 144 to the wind collection side 100C of the wind turbine 100, resulting in more wind collected by the airfoils 124, increased rotation speed of the rotor 120, and increased electrical power output by the generator 132.

In some embodiments, the panel 144 protrudes from the frame 110 at an angle θ from the direction of incident wind W. In some embodiments, the angle θ is in the range of about 30-degrees to about 60-degrees. In some embodiments, the angle θ is in the range of about 35-degrees to about 55-degrees. In some embodiments, the angle θ is in the range of about 40-degrees to about 50-degrees. In some embodiments, the angle θ is in the range of about 40-degrees to about 45-degrees. In some embodiments, the angle θ is about 40-degrees. In some embodiments, the panel 144 has a substantially rectangular shape. In some embodiments, the panel 144 has a substantially concave shape toward the wind collection side 100C of the wind turbine 100. In some embodiments, the panel 144 has a proximal portion 146 that is substantially curved and a distal portion 148 that is substantially linear, as shown in FIG. 8. However, the present technology is not limited thereto and contemplates embodiments where the panel 144 has any different shape and/or orientation that is configured to capture and divert incident wind from the wind drag side 100D to the wind collection side 100C to improve the efficiency of the wind turbine 100.

As shown in FIGS. 7A-7B, in some embodiments, the first axial end 142A is slidably connected to a circumferential edge 112E of the top portion 112 and the second axial end 142B is slidably connected to a circumferential edge 114E of the bottom portion 114 such that the wind deflector 140 is slidable along the circumference of the frame 110. In some embodiments, the rod 142 has a first ball 142X at the first axial end 142A that is configured to be slidably positioned within a circumferential track 112T of the top portion 112, and a second ball 142Y at the second axial end 142B that is configured to be slidably positioned within a circumferential track 114T of the bottom portion 114 such that the wind deflector 140 is slidable along the circumference of the frame 110. In some embodiments, a wind vane 150 is connected to a top surface 113 of the top portion 112. The wind vane 150 is configured to rotate and align with the direction of incident wind W. The wind vane 150 has an arm 152 that is connected to the first ball 142X of the wind deflector 140 such that rotation of the wind vane 150 slides the rod 142 along the circumference of the frame 110 to reposition the wind deflector 140. In some embodiments, the wind turbine 100 includes a plurality of wind sensors positioned around the frame 110 and a controller in communication with the wind sensors. The controller receives wind direction data from the wind sensors and communicates an electrical signal to a motor that is configured to slide the rod 142 along the circumferential tracks 112T/114T to reposition the wind deflector 140 based on the direction of incident wind W. Thus, the wind deflector 140 is slidable along the circumference of the frame 110 based on the direction of incident wind W to ensure that the panel 144 is positioned to divert wind incident on the wind drag side 100D to the wind collection side 100C of the wind turbine 100.

In some embodiments, the wind turbine 100 includes a cage 160 that is connected to the frame 110, as shown in FIGS. 5-6. The cage 150 connects to at least one of the plurality of supports 116 that connect the top portion 112 and the bottom portion 114 of the frame 110. The cage 160 at least partially encloses the rotor 120 to protect the rotor 120 from debris, animals, etc. In some embodiments, the cage 160 has a substantially cylindrical shape. However, the present technology is not limited thereto and contemplates embodiments where the cage 160 has a different shape, such as a triangular shape, a rectangular shape, a pentagonal shape, a hexagonal shape, etc. In some embodiments, the cage 160 is connected to two adjacent supports 116 and wraps partially around the frame 110 leaving a portion of the frame 110 (e.g., one quadrant) exposed, as shown in FIG. 6. The exposed portion allows the frame 110 to be mounted to a flat surface of a structure 170 (e.g., a face of a building) via the supports 116 on either side of the exposed portion. In some embodiments, the frame 110 is configured to be mounted to a vertical pole by connecting at least one of the supports 116 to a sleeve that is aligned with the longitudinal axis L, which is configured to be placed over and clamped to the vertical pole. In some embodiments, the frame 110 is configured to be mounted atop a vertical pole by connecting the bottom portion 114 to the top of the vertical pole.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology. The term “and/or” means any one of the items, any combination of the items, or all of the items with which this term is associated.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

1. A wind turbine comprising:
a frame having a top portion and a bottom portion defining a longitudinal axis of the wind turbine;
a cylindrical core substantially centrally located in the frame along the longitudinal axis and configured to rotate about the longitudinal axis;
at least one pair of airfoils connected to the cylindrical core and configured to collect incident wind to rotate the cylindrical core, the airfoils of the at least one pair of airfoils are diametrically opposed to each other and wrap around the cylindrical core along the longitudinal axis in a double-helical shape thereby forming a wind collection side on a first longitudinal side of the wind turbine and a wind drag side on a second longitudinal side of the wind turbine; and
a wind deflector connected to the frame and configured to divert wind incident on the wind drag side to the wind collection side for collection by the at least one pair of airfoils.

2. The wind turbine of claim 1, wherein the cylindrical core comprises a dowel passing therethrough along the longitudinal axis, the dowel having a first axial end connected to the top portion of the frame via a ball bearing and a second axial end connected to a gearbox adjacent the bottom portion of the frame such that the cylindrical core is configured to rotate within the frame.

3. The wind turbine of claim 2, wherein the gearbox comprises a generator connected to the second axial end of the dowel such that rotation of the cylindrical core drives the generator to produce electrical power.

4. The wind turbine of claim 1, wherein the top portion of the frame and the bottom portion of the frame each have an annular shape, and the wind deflector has a first axial end slidably connected to a circumferential edge of the top portion and a second axial end slidably connected to a circumferential edge of the bottom portion such that the wind deflector is slidable along a circumference the frame.

5. The wind turbine of claim 1, wherein the frame further comprises a plurality of supports connecting the top portion and the bottom portion, and a cylindrical cage connected to at least one of the plurality of supports and at least partially enclosing the cylindrical core.

6. The wind turbine of claim 5, wherein the frame is configured to be mounted to a vertical structure via at least one of the plurality of supports.

7. The wind turbine of claim 1, wherein the wind deflector comprises:
a rod aligned with the longitudinal axis, the rod having a first axial end slidably positioned in a first perimeter track of the top portion of the frame and a second axial end slidably positioned in a second perimeter track of the bottom portion of the frame such that the wind deflector is slidable along a perimeter of the frame; and
a panel connected to the rod and protruding outward from the frame, the panel is configured to collect wind incident on the wind drag side of the wind turbine and divert to the collected wind to the wind collection side of the wind turbine.

8. The wind turbine of claim 7, further comprising a wind vane mounted atop the frame and configured to rotate and align with a direction of incident wind, the wind vane having an arm connected to the rod of the wind deflector configured to slide the wind deflector along the perimeter of the frame as the wind vane rotates.

9. The wind turbine of claim 7, wherein the panel protrudes outward from the frame at an angle in the range of about 30-degrees to about 60-degrees from a direction of the incident wind.

10. The wind turbine of claim 7, wherein the panel protrudes outward from the frame at an angle in the range of about 40-degrees to about 50-degrees from a direction of the incident wind.

11. The wind turbine of claim 7, wherein the panel protrudes outward from the frame at an angle of about 40-degrees from a direction of the incident wind.

12. The wind turbine of claim 1, wherein the wind deflector has a substantially rectangular shape.

13. The wind turbine of claim 1, wherein the wind deflector has a substantially concave shape toward the wind collection side of the wind turbine.

14. The wind turbine of claim 1, wherein the wind deflector has a proximal portion that is curved toward the wind collection side of the wind turbine, and a distal portion that is substantially linear.

15. A system for producing electrical power from wind flowing in a direction, the system comprising:
at least one wind turbine, each of the at least one wind turbines comprising:
a cylindrical core having a first axial end and a second axial end defining a longitudinal axis of the wind turbine; and
at least one pair of airfoils connected to the cylindrical core and configured to collect incident wind to rotate the cylindrical core about the longitudinal axis, the airfoils of the at least one pair of airfoils are diametrically opposed to each other and wrap around the cylindrical core along the longitudinal axis in a double-helical shape thereby forming a wind collection side on a first longitudinal side of the wind turbine and a wind drag side on a second longitudinal side of the wind turbine;
at least one generator, each of the at least one generators is connected to a respective one of the at least one wind turbines, the generator connected to the second axial end of the cylindrical core such that rotation of the cylindrical core drives the generator to produce electrical power; and
at least one wind deflector, each of the at least one wind deflectors is connected to a respective one of the at least one wind turbines, the wind deflector configured to divert wind incident on the wind drag side to the wind collection side for collection by the at least one pair of airfoils.

16. The system of claim 15, further comprising a frame supporting the cylindrical core, the frame comprising a top portion connected to the first axial end of the cylindrical core via a ball bearing, and a bottom portion connected to the cylindrical core adjacent the generator such that the cylindrical core is configured to rotate within the frame.

17. The system of claim 16, wherein the top portion of the frame and the bottom portion of the frame each have an annular shape, and the wind deflector has a first axial end slidably connected to a circumferential edge of the top portion and a second axial end slidably connected to a circumferential edge of the bottom portion such that the wind deflector is slidable along a circumference of the frame.

18. The system of claim 16, wherein the frame further comprises a plurality of supports connecting the top portion and the bottom portion, and a cylindrical cage connected to at least one of the plurality of supports and at least partially enclosing the cylindrical core.

19. The system of claim 18, wherein the frame is configured to be mounted to a vertical structure via at least one of the plurality of supports.

20. The system of claim 16, wherein the wind deflector comprises:
a rod aligned with the longitudinal axis, the rod having a first axial end slidably positioned in a first perimeter track of the top portion of the frame and a second axial end slidably positioned in a second perimeter track of the bottom portion of the frame such that the wind deflector is slidable along a perimeter of the frame; and
a panel connected to the rod and protruding outward from the frame, the panel is configured to collect wind incident on the wind drag side of the wind turbine and divert to the collected wind to the wind collection side of the wind turbine.

21. The system of claim 20, wherein the panel protrudes outward from the frame at an angle of about 40-degrees from a direction of the incident wind.

22. The system of claim 15, wherein the wind deflector has a substantially concave shape toward the wind collection side of the wind turbine.
